(19) United States
(12) Patent Application Publication
(10) Pub. No.: US 2026/0319926 A1
(43) Pub. Date: Oct. 15, 2026

(54) CONTINUOUS PRODUCTION LOG MONITORING-DRIVEN AUTOMATED TEST CASE GENERATION AND ERROR CATEGORIZATION

(71) Applicant: Dell Products L.P., Round Rock, TX (US)

(72) Inventors: Robin Kedia, Singapore (SG); Antony Prabakaran Jayaveeran, Singapore (SG); Prabhagharan Dhanasekaran Kamatchiammal, Singapore (SG); Sabarinath Subramani, Singapore (SG)

(73) Assignee: Dell Products L.P., Round Rock, TX (US)

(21) Appl. No.: 19/188,186

(22) Filed: Apr. 24, 2025

(30) Foreign Application Priority Data
Apr. 11, 2025 (CN) 202510458646.2

(51) Int. Cl. G06F 11/3668

(52) U.S. Cl. CPC G06F 11/3684

(57) ABSTRACT

Methods, system, and non-transitory processor-readable storage medium for a test generation system are provided herein. An example method includes retrieving, by a test generation system, in response to an alert notification, a sequence of log entries associated with a transaction identifier from a centralized log storage system. The test generation system processes the sequence of log entries using a log parsing engine to generate structured log data. The test generation system generates a test case based on the structured log data using a test case generation engine, wherein the test case comprises a test objective, steps to reproduce the error condition, expected results, environment details, and test data.

### FIELD

The field relates generally to software test cases, within information processing systems.

### BACKGROUND

Software applications in production environments often encounter errors and exceptions that were not anticipated during testing.

### SUMMARY

Illustrative embodiments provide techniques for implementing a test generation system in a storage system. For example, illustrative embodiments comprise a test generation system, in response to an alert notification, retrieving a sequence of log entries associated with a transaction identifier from a centralized log storage system. The test generation system processes the sequence of log entries using a log parsing engine to generate structured log data. The test generation system generates a test case based on the structured log data using a test case generation engine, where the test case comprises a test objective, steps to reproduce the error condition, expected results, environment details, and test data. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 illustrates an information processing system including a test generation system, in an illustrative embodiment.

FIG. 2 illustrates a flow diagram of a process for a test generation system, in an illustrative embodiment.

FIG. 3 illustrates a system architecture for a test generation system, in an illustrative embodiment.

FIG. 4 illustrates parsed log information mapped into a predefined data format, in an illustrative embodiment.

FIG. 5 illustrates a sample output of a generated test case, in an illustrative embodiment.

FIG. 6 illustrates a sample of error classification data generated by the error classification engine, in an illustrative embodiment.

FIGS. 7 and 8 show examples of processing platforms that may be utilized to implement at least a portion of a test generation system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing a test generation system, which technique may be used to generate test cases based on monitoring logs that are created during execution of software applications. The test generation system retrieves, in response to an alert notification, a sequence of log entries associated with a transaction identifier from a centralized log storage system. The test generation system processes the sequence of log entries using a log parsing engine to generate structured log data. The test generation system generates a test case based on the structured log data using a test case generation engine, where the test case comprises a test objective, steps to reproduce the error condition, expected results, environment details, and test data.

Production systems running software applications may encounter errors and issues. These errors and issues are identified in application logs that capture details during the execution of the software applications. Ideally, a regression test case could capture these errors and issues so that these can be identified and resolved during regression testing and not occur during production.

Conventional technologies rely on manually creating test cases which fails to take into account the actual errors that are discovered in application logs. Conventional technologies fail to efficiently parse raw application logs, process them into meaningful insights, and convert them into structured data. Conventional technologies fail to analyze application logs to generate missing test scenarios and test cases. Conventional technologies manually classify and integrate test cases into regression test suites which is time-consuming and prone to human error.

By contrast, in at least some implementations in accordance with the current technique as described herein, an improvement in generating test cases is achieved by a test generation system that retrieves, in response to an alert notification, a sequence of log entries associated with a transaction identifier from a centralized log storage system. The test generation system processes the sequence of log entries using a log parsing engine to generate structured log data. The test generation system generates a test case based on the structured log data using a test case generation engine, where the test case comprises a test objective, steps to reproduce the error condition, expected results, environment details, and test data.

Thus, a goal of the current technique is to provide a method and a system for a test generation system that parses application logs to obtain error information that is then used to automatically generate test cases. Another goal is to generate test cases including identifying the workflow, errors, and failure points. Another goal is to utilize a natural language processing engine to parse the application logs to generate the test scenarios in a human readable format. Another goal is to classify errors derived from application logs and correlate the errors with missing or inadequate test cases to provide targeted testing improvement. Another goal is to ensure issues discovered in production test environments are correctly addressed in future testing cycles. Yet another goal is to provide an adaptable technique that can be applied to various domain-specific use cases.

In at least some implementations in accordance with the current technique described herein, the use of a test generation system can provide one or more of the following advantages: automatically generates, classifies, and integrates test cases derived from production logs using natural language processing, automatically adds missing test cases to a regression test case suite, and automatically refines the regression test case suite with each execution of the software applications.

In contrast to conventional technologies, in at least some implementations in accordance with the current technique as described herein, an improvement in generating test cases is achieved by a test generation system that retrieves, in response to an alert notification, a sequence of log entries associated with a transaction identifier from a centralized log storage system. The test generation system processes the sequence of log entries using a log parsing engine to generate structured log data. The test generation system generates a test case based on the structured log data using a test case generation engine, where the test case comprises a test objective, steps to reproduce the error condition, expected results, environment details, and test data.

In an example embodiment of the current technique, the test generation system compares the generated test case with existing test cases in a test case repository using vector embeddings to identify similar test cases and stores the generated test case in the test case repository when no similar test cases are identified.

In an example embodiment of the current technique, the test generation system converts the existing test cases into vector embeddings using a pre-trained language model, stores the embeddings in a vector database, and calculates cosine similarity scores between the generated test case and the existing test cases.

In an example embodiment of the current technique, the vector database comprises at least one of Pinecone and Milvus.

In an example embodiment of the current technique, the test generation system categorizes the cosine similarity scores into percentage ranges to identify relevant matches.

In an example embodiment of the current technique, the alert notification is received from an alerting system indicating an error condition in a production environment.

In an example embodiment of the current technique, the alert notification comprises predefined error patterns and thresholds for triggering alerts.

In an example embodiment of the current technique, the centralized log storage system comprises at least one of ELK Stack, Splunk, or Fluentd.

In an example embodiment of the current technique, the test generation system identifies log entries based on a transaction ID or timestamp associated with the alert.

In an example embodiment of the current technique, the test generation system extracts metadata comprising date, time, component information, and environment details and

extracts log information comprising error messages, stack traces, and test data.

In an example embodiment of the current technique, the metadata comprises a log type selected from at least one of entry point logs, user action logs, and failure point logs.

In an example embodiment of the current technique, the test generation system uses a transformer-based language model with Wordpiece tokenization.

In an example embodiment of the current technique, the test generation system uses few-shot prompting with domain-specific examples.

In an example embodiment of the current technique, the environment details comprise at least one of operating system name, operating system version, database, database version, and hardware specifications.

In an example embodiment of the current technique, the test generation system classifies the error condition using an error classification engine to determine at least one of error type, severity, and impact.

In an example embodiment of the current technique, the error type comprises at least one of infrastructure related, data issue, and broken functionality.

In an example embodiment of the current technique, the impact comprises at least one of service impact and transaction failure.

In an example embodiment of the current technique, the test case is generated in a human-readable format.

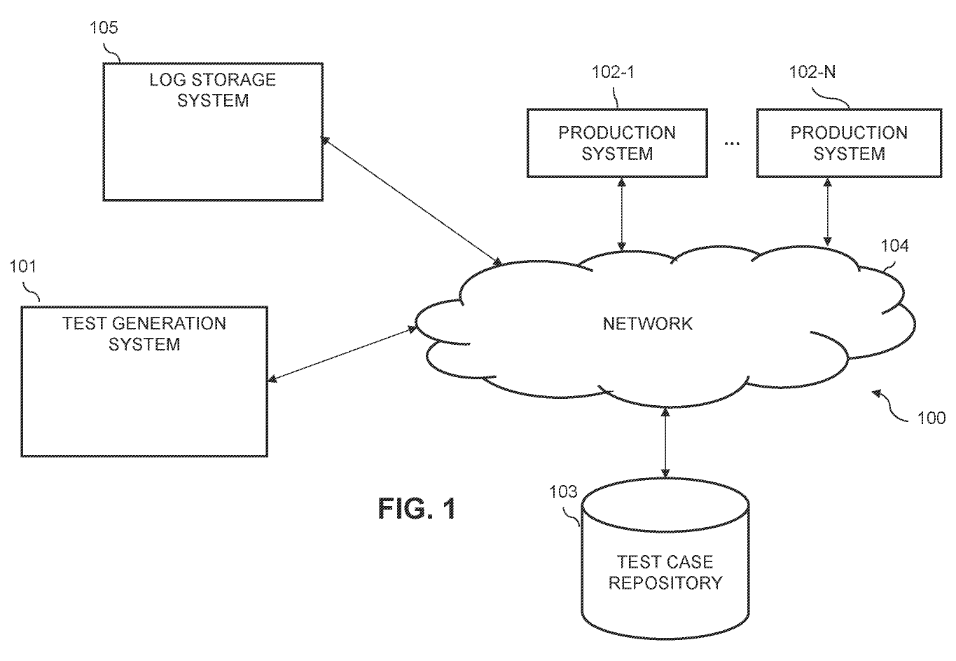

FIG. 1 shows a computer network (also referred to herein as an information processing system) 100 configured in accordance with an illustrative embodiment. The computer network 100 comprises a test generation system 101, a log storage system 105, a test case repository 103, and production systems 102-N. The test generation system 101, log storage system 105, test case repository 103, and production systems 102-N are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. The test generation system 101 may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the test generation system 101, log storage system 105, and production systems 102-N may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The test generation system 101, log storage system 105, and production systems 102-N in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the test generation system 101 are one or more input-output devices, which illustratively comprise keyboards, displays or other types of input-output devices in any combination. Such input-output devices can be used, for example, to support one or more user interfaces to the test generation system 101, as well as to support communication between the test generation system 101 and other related systems and devices not explicitly shown. For example, a dashboard may be provided for a user to view results produced by the test generation system 101. One or more input-output devices may also be associated with any of the log storage system 105, test case repository 103, and production systems 102-N.

Additionally, the test generation system 101 in the FIG. 1 embodiment is assumed to be implemented using at least one processing device. Each such processing device generally comprises at least one processor and an associated memory, and implements one or more functional modules for controlling certain features of the test generation system 101.

More particularly, the test generation system 101 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the test generation system 101 to communicate over the network 104 with the log storage system 105, test case repository 103, and production systems 102-N and illustratively comprises one or more conventional transceivers.

A test generation system 101 may be implemented at least in part in the form of software that is stored in memory and executed by a processor, and may reside in any processing device. The test generation system 101 may be a standalone plugin that may be included within a processing device.

It is to be understood that the particular set of elements shown in FIG. 1 for test generation system 101 involving the test generation system 101, log storage system 105, test case repository 103, and production systems 102-N of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the test generation system 101 can be on and/or part of the same processing platform.

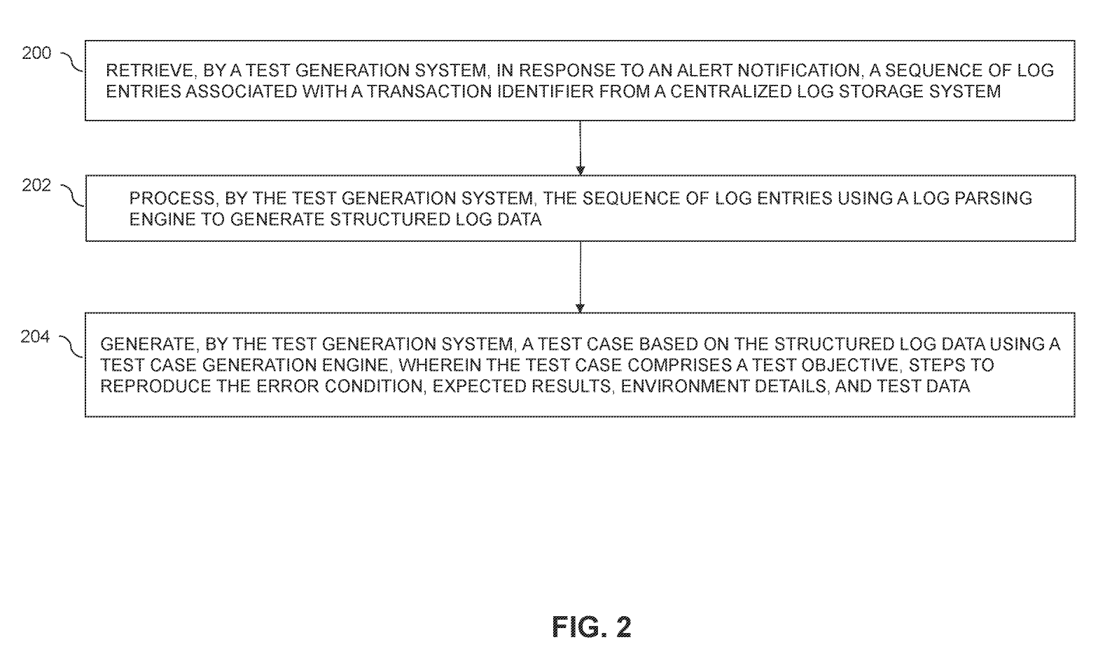

An exemplary process of test generation system 101 in computer network 100 will be described in more detail with reference to, for example, the flow diagram of FIG. 2.

FIG. 2 is a flow diagram of a process for execution of the test generation system 101 in an illustrative embodiment. It is to be understood that this particular process is only an example, and additional or alternative processes can be carried out in other embodiments.

At 200, the test generation system 101, in response to an alert notification, retrieves a sequence of log entries associated with a transaction identifier from a centralized log storage system 105. In an example embodiment, the centralized log storage system 105 comprises at least one of ELK Stack, Splunk, or Fluentd. In an example embodiment, the test generation system 101 comprises the log storage system 105 to act as a centralized log aggregation solution to collect logs from various sources in the production environment comprising the production systems 102-N. In an example embodiment, the test generation system 101 stores the aggregated logs in a searchable and scalable storage system to enable quick retrieve and analysis.

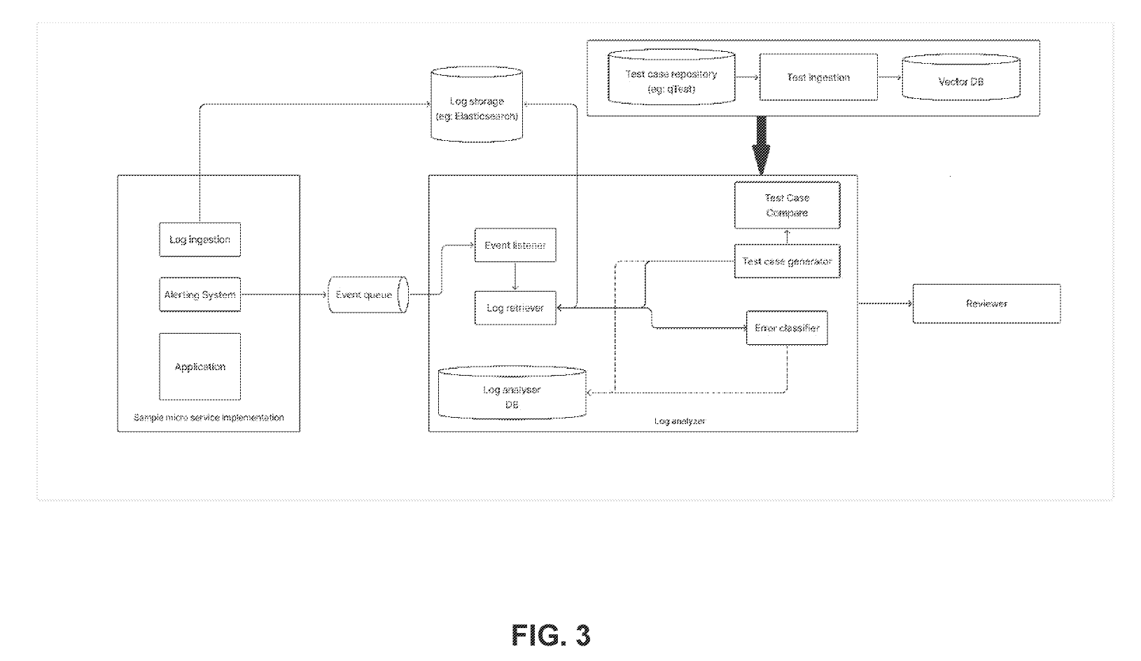

In an example embodiment, the alert notification is received from an alerting system indicating an error condition in a production environment. In an example embodiment, as production systems 102-N execute applications, logs associated with those applications (i.e., application logs, production logs, or production application logs) are stored in a centralized searchable log datastore as illustrated in FIG. 3. An alerting system is integrated to raise alerts whenever application errors or exceptions occur. In an example embodiment, the alerting system integration comprises alert configuration and alert trigger. The alert configuration comprises alert rules that are set up in the alerting system (for example, Prometheus Alert Manger, Splunk Alerts, etc.) based on predefined error patterns, thresholds, or specific conditions in the logs. The alert trigger comprises a notification that is sent by the alerting system to a log analyzer when an alert is triggered. In an example embodiment, the log storage system 105 comprises the alert system and the centralized searchable log datastore.

In an example embodiment, when an alert is triggered, the relevant application logs specific to the transactions are received and transaction flows are traced in sequence. In an example embodiment, the alert notification comprises predefined error patterns and thresholds for triggering alerts. In an example embodiment, the test generation system 101 identifies log entries based on a transaction ID or timestamp associated with the alert. In an example embodiment, the test generation system 101 comprises log retrieval and log tracing. In an example embodiment, when the test generation system 101 receives the alert, the test generation system 101 queries the logs from the log datastore using a TraceID in the alert. This includes all the logs starting from the entry point and logs pertaining to user actions until the failure point.

In an example embodiment, when the test generation system 101 receives the alert, log retrieval is performed by the log analyzer which identifies the relevant log entries by parsing the logs associated with the specific transaction or time frame indicated by the alert. In an example embodiment, the test generation system 101 performs log tracing by tracing the entire transaction flow by linking log entries (i.e., using transaction IDs, correlation IDs, or timestamps) to reconstruct the sequence of events leading up to the error or exception.

At 202, the test generation system 101 processes the sequence of log entries using a log parsing engine to generate structured log data. In an example embodiment, the test generation system 101 adds additional context to the logs, such as the environment details and system configuration such as hardware specifications. In an example embodiment, this information is present in the received alert. In an example embodiment, the environment details comprise at least one of operating system name, operating system version, database, and database version.

In an example embodiment, the test generation system 101 uses a natural language processing (NLP) based large language model (LLM) to analyze the logs to extract key information. In an example embodiment, the test generation system 101 uses a transformer-based LLM, such as GPT or BERT to synthesize the logs using an effective tokenization technique such as Wordpiece, and constructs structured data for each of the log entries. In an example embodiment, the test generation system 101 comprises a log retrieval module that retrieves logs for any particular transaction. The test generation system 101 generates structured data sets for the sequence of logs retrieved by the log retrieval module. The test generation system 101 feeds the structured data sets into a test generation module that comprises a test case generation engine to generate test steps and test data.

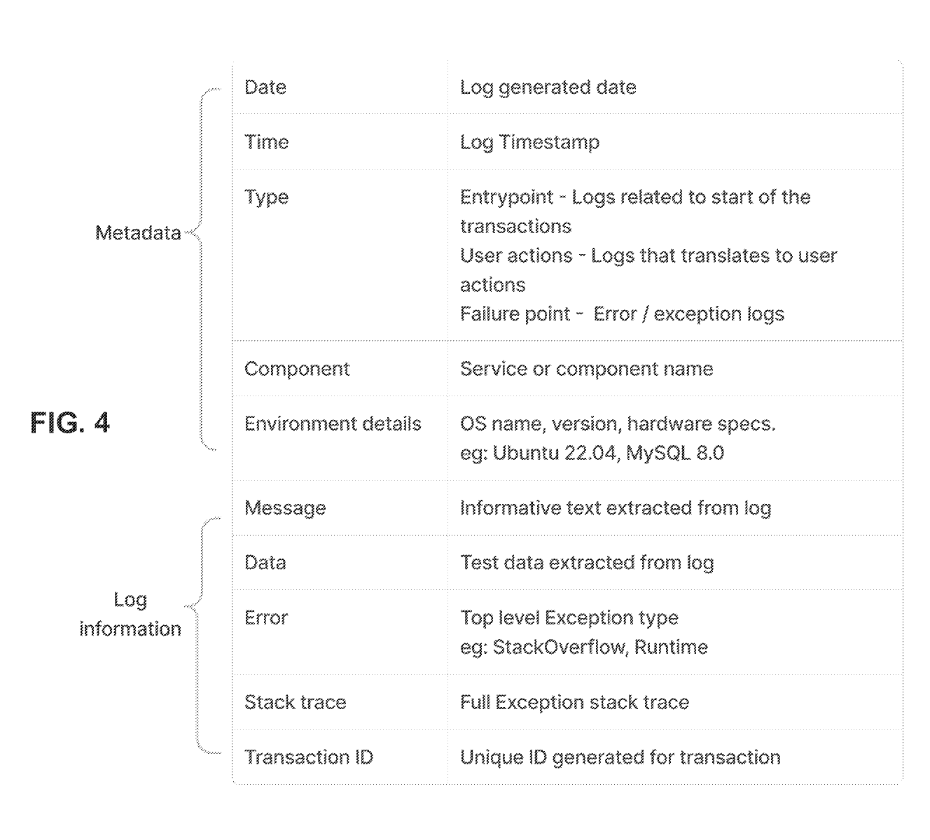

In an example embodiment, the test generation system 101 feeds the retrieved log traces into the log parsing engine (i.e., a natural language processing (NLP) engine) which processes the unstructured log data into meaningful information, such as error messages, stack traces, and user actions. FIG. 4 illustrates the parsed log information mapped into a predefined data format. In an example embodiment, the log parsing engine uses a fine-tuned LLM that can effectively parse the logs, extract key information and convert the data into a standard template. In an example embodiment, the log parsing engine deploys the few-shot prompting technique with more domain-specific examples in the prompt to scrutinize the logs and extract data.

In an example embodiment, the test generation system 101 extracts metadata comprising date, time, component information, and environment details, and extracts log information comprising error messages, stack traces, and test data. In an example embodiment, the metadata comprises a log type selected from at least one of entry point logs, user action logs, and failure point logs.

In an example embodiment, the test generation system 101 comprises an error classification engine that consumes the structured data set derived from the log traces, and categorizes them based on the nature of the issue.

At 204, the test generation system 101 generates a test case based on the structured log data using a test case generation engine, where the test case comprises a test objective, steps to reproduce the error condition, expected results, environment details, and test data.

In an example embodiment, the test case generation engine comprises a pre-trained LLM capable of understanding the structured data template extracted from application logs (as illustrated in FIG. 4) and automatically generate test cases. The extracted data sequence enables the test case generation engine to comprehend critical elements such as the entry point, user workflow, failure points and the test data to effectively translate these critical elements into test cases designed to reproduce the identified issue.

In an example embodiment, the structured data set is chained to a test case generation engine that generates corresponding test cases. The test cases are generated with the intent of helping users to replicate the conditions that lead to the error or exception. In an example embodiment, the generated test case comprises defining inputs, expected outputs, and relevant test conditions. In an example embodiment, the test generation system 101 generates the test case in a human-readable format.

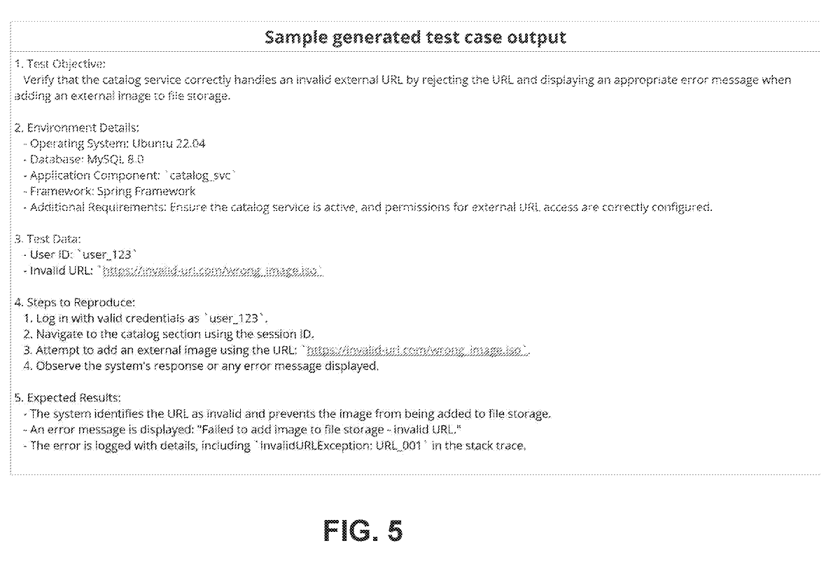

In an example embodiment, the structured data (i.e., the structured log data) is passed as input into the test case generation engine to generate a test case with a test objective, steps to reproduce, expected results, environment details, and test data. The test objective is the high-level goal of the test case, for example, "Validate that the database connection is not lost during user login". The steps to reproduce are a step-by-step sequence of actions leading up to the error. The expected results are the expected behavior if the test case passes, for example, "The user should be logged in successfully without a database connection error". The environment details are information about the system environment in which the error occurred. The test data comprises data inputs that are relevant to the test case. FIG. 5 illustrates a sample output of a generated test case.

In an example embodiment, the test generation system 101 compares the generated test case with existing test case suites in the test case repository 103 to check for overlap or gaps. A vector database is used to index all the test cases in the test case repository 103 for the test generation system 101 to search the newly generated test case. In an example embodiment, the test generation system 101 performs the comparison using vector embeddings to identify similar test cases. In an example embodiment, the test generation system 101 converts the existing test cases into vector embeddings using a test comparison engine (i.e., pre-trained language model for example, Sentence Transformers library), and stores the embeddings in a vector database. In an example embodiment, the vector database comprises at least one of Pinecone and Milvus since these vector databases are optimized for high-dimensional data retrieval.

In an example embodiment, the test generation system 101 converts the test cases from the test case repository 103 into vector embeddings and stores them in a vector database. In an example embodiment, once the test case generation engine generates the newly generated test case, the test comparison engine transforms the newly generated test case into a vector embedding using the same embedding model. The test comparison engine compares the newly generated test case (now transformed into a vector) with the vector embeddings in the vector database. If there is no match, the test generation system 101 stores the newly generated test case in the test case repository 103.

The test generation system 101 queries the vector database to find similar cases based on cosine similarity. The test generation system 101 calculates cosine similarity scores between the generated test case and the existing test cases. The vector database returns a ranked list of matches, which can be converted into percentage similarity scores. In an example embodiment, the test generation system 101 categorizes the cosine similarity scores into percentage ranges to identify relevant matches for example, 90-100%, 80-89%, etc., to highlight the most relevant matches. The test generation system 101 leverages efficient vector indexing and search capabilities to streamline the validation and comparison of test cases to ensure quick identification of duplicates or near-duplicates within the repository. If any match is found, the test generation system 101 will not flag the newly generated test case as a new test case. The test generation system 101 stores the generated test case in the test case repository 103 when no similar test cases are identified. FIG. 3 illustrates a system architecture for the test generation system 101.

In an example embodiment, the test generation system 101 comprises an error classification engine to identify the error labels from the structured log data template that the test generation system 101 extracted from the application logs. In an example embodiment, the error classification engine is a pre-trained LLM that understands the structured log data template. The error classification engine classifies the errors by analyzing the key information like error type, error message, detailed stack trace, environment and system configuration. In an example embodiment, the error classification engine is trained using a variety of training data sets to improve the performance of the error labeling.

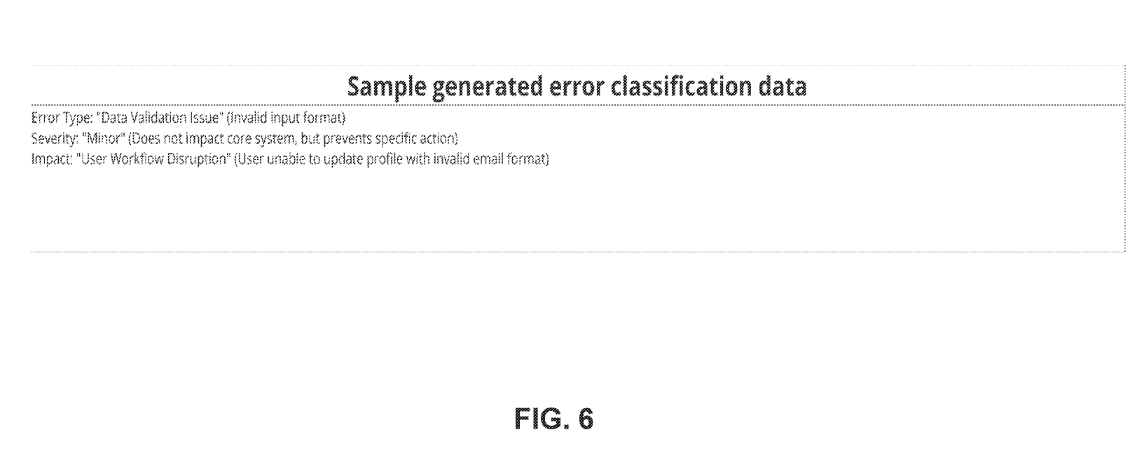

In an example embodiment, the test generation system 101 passes the structured data set through the error classification engine to classify the issue type as at least one of error type, severity, and impact. In an example embodiment, the error type comprises at least one of infrastructure related, data issue, and broken functionality. For example, the error type details what kind of issue the log describes. In an example embodiment, the severity defines how critical the issue is, such as minor, major or critical. In an example embodiment, the impact comprises at least one of service impact and transaction failure. For example, what part of the system or workflow is affected. FIG. 6 illustrates a sample of error classification data generated by the error classification engine.

In an example embodiment, the test generation system 101 stores the test cases and error classifications in the test case repository 103 for users to review and add to their existing test case repositories. In an example embodiment, the newly generated test cases may be reviewed by a reviewer and added to a regression test repository.

The above-described illustrative embodiments provide significant advantages relative to conventional approaches. For example, some embodiments are configured to significantly optimize generating regression test cases. These and other embodiments can effectively improve detecting anomalies prior to software applications executing on production systems. Embodiments disclosed herein automatically generate, classify, and integrate test cases derived from production logs using natural language processing. Embodiments disclosed herein automatically add missing test cases to a regression test case suite. Embodiments disclosed herein automatically refine the regression test case suite with each execution of software applications.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

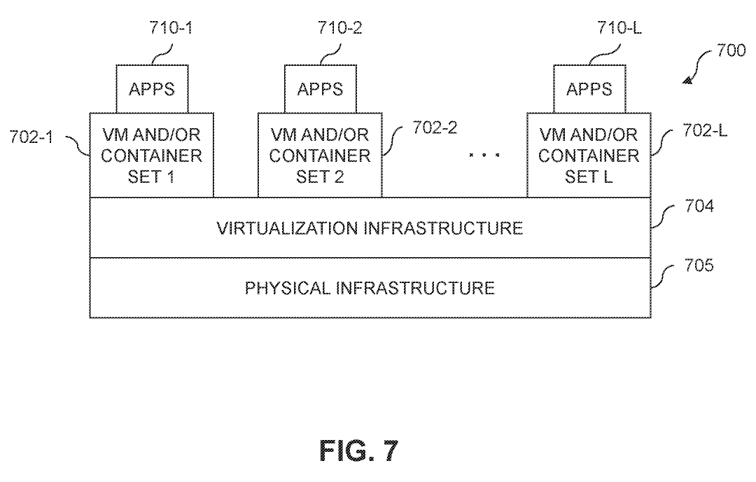

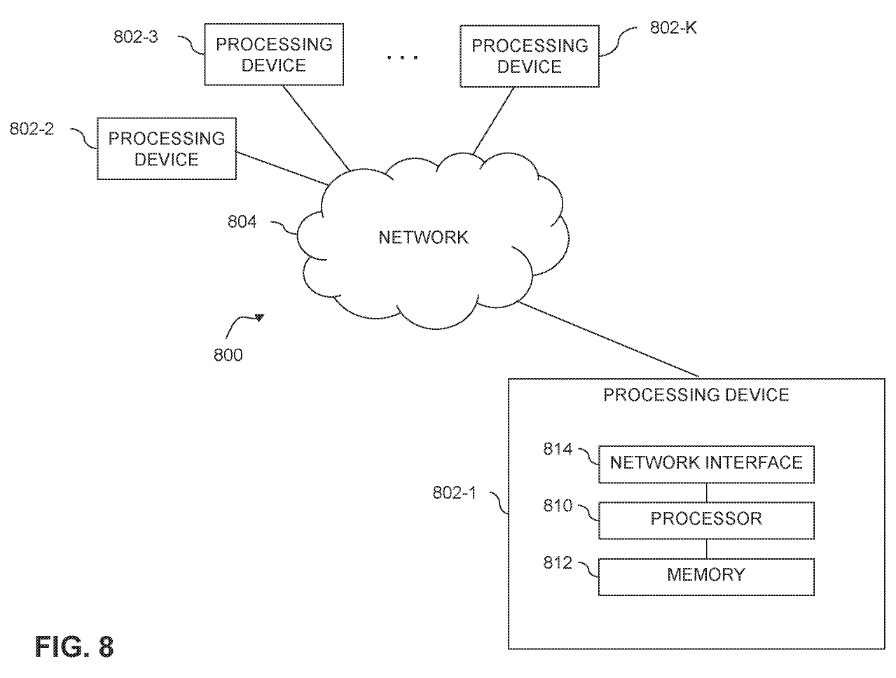

Illustrative embodiments of processing platforms will now be described in greater detail with reference to FIGS. 7 and 8. Although described in the context of the information processing system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that are utilized to implement at least a portion of the information processing system 100. The cloud infrastructure 700 comprises multiple virtual machines (VMs) and/or container sets 702-1, 702-2, . . . 702-L implemented using virtualization infrastructure 704. The virtualization infrastructure 804 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 800 further comprises sets of applications 710-1, 710-2, . . . 710-L running on respective ones of the VMs/container sets 702-1, 702-2, . . . 702-L under the control of the virtualization infrastructure 704. The VMs/container sets 702 comprise respective VMs, respective sets of one or more containers, or respective sets of one or more containers running in VMs. In some implementations of the FIG. 7 embodiment, the VMs/container sets 702 comprise respective VMs implemented using virtualization infrastructure 704 that comprises at least one hypervisor.

A hypervisor platform may be used to implement a hypervisor within the virtualization infrastructure 704, where the hypervisor platform has an associated virtual infrastructure management system. The underlying physical machines comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 1000 in this embodiment comprises a portion of the information processing system 100 and includes a plurality of processing devices, denoted 802-1, 802-2, 802-3, . . . 802-K, which communicate with one another over a network 804.

The network 804 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 802-1 in the processing platform 800 comprises a processor 810 coupled to a memory 812.

The processor 810 comprises a microprocessor, a microcontroller, an application-specific integrated circuit (ASIC), a field-programmable gate array (FPGA) or other type of processing circuitry, as well as portions or combinations of such circuitry elements.

The memory 812 comprises random access memory (RAM), read-only memory (ROM) or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
retrieving, by a test generation system, in response to an alert notification, a sequence of log entries associated with a transaction identifier from a centralized log storage system;
processing, by the test generation system, the sequence of log entries using a log parsing engine to generate structured log data; and
generating, by the test generation system, a test case based on the structured log data using a test case generation engine, wherein the test case comprises a test objective, steps to reproduce the error condition, expected results, environment details, and test data, wherein the method is implemented by at least one processing device comprising a processor coupled to a memory.

2. The method of claim 1 further comprising:
comparing the generated test case with existing test cases in a test case repository using vector embeddings to identify similar test cases; and
storing the generated test case in the test case repository when no similar test cases are identified.

3. The method of claim 2 wherein comparing the generated test case with existing test cases comprises:
converting the existing test cases into vector embeddings using a pre-trained language model;
storing the embeddings in a vector database; and
calculating cosine similarity scores between the generated test case and the existing test cases.

4. The method of claim 3 wherein the vector database comprises at least one of Pinecone and Milvus.

5. The method of claim 3 further comprising:
categorizing the cosine similarity scores into percentage ranges to identify relevant matches.

6. The method of claim 1 wherein the alert notification is received from an alerting system indicating an error condition in a production environment.

7. The method of claim 1 wherein the alert notification comprises predefined error patterns and thresholds for triggering alerts.

8. The method of claim 1 wherein the centralized log storage system comprises at least one of ELK Stack, Splunk, or Fluentd.

9. The method of claim 1 wherein retrieving, in response to the alert notification, the sequence of log entries comprises:
identifying log entries based on a transaction ID or timestamp associated with the alert.

10. The method of claim 1 wherein processing the sequence of log entries using the log parsing engine comprises:
extracting metadata comprising date, time, component information, and environment details; and
extracting log information comprising error messages, stack traces, and test data.

11. The method of claim 10 wherein the metadata comprises a log type selected from at least one of entry point logs, user action logs, and failure point logs.

12. The method of claim 1 wherein processing the sequence of log entries using the log parsing engine comprises:
using a transformer-based language model with Wordpiece tokenization.

13. The method of claim 1 wherein generating, using the test case generation engine, the test case based on the structured log data comprises:
using few-shot prompting with domain-specific examples.

14. The method of claim 1 wherein the environment details comprise at least one of operating system name, operating system version, database, database version, and hardware specifications.

15. The method of claim 1 further comprising classifying the error condition using an error classification engine to determine at least one of error type, severity, and impact.

16. The method of claim 15 wherein the error type comprises at least one of infrastructure related, data issue, and broken functionality.

17. The method of claim 15 wherein the impact comprises at least one of service impact and transaction failure.

18. The method of claim 1 wherein the test case is generated in a human-readable format.

19. A system comprising:
at least one processing device comprising a processor coupled to a memory;
the at least one processing device being configured:
to retrieve, by a test generation system, in response to an alert notification, a sequence of log entries associated with a transaction identifier from a centralized log storage system;
to process, by the test generation system, the sequence of log entries using a log parsing engine to generate structured log data; and
to generate, by the test generation system, a test case based on the structured log data using a test case generation engine, wherein the test case comprises a test objective, steps to reproduce the error condition, expected results, environment details, and test data.

20. A computer program product comprising a non-transitory processor-readable storage medium having stored therein program code of one or more software programs, wherein the program code when executed by at least one processing device causes said at least one processing device:
to retrieve, by a test generation system, in response to an alert notification, a sequence of log entries associated with a transaction identifier from a centralized log storage system;
to process, by the test generation system, the sequence of log entries using a log parsing engine to generate structured log data; and
to generate, by the test generation system, a test case based on the structured log data using a test case generation engine, wherein the test case comprises a test objective, steps to reproduce the error condition, expected results, environment details, and test data.
